(19) United States
(12) Patent Application Publication
(10) Pub. No.: US 2009/0063089 A1
(43) Pub. Date: Mar. 5, 2009

(54) Method and System For Detecting the type of tire

(76) Inventors: Andreas Kobe, Bensheim (DE); Martin Griesser, Eschborn (DE)

Correspondence Address: CONTINENTAL TEVES, INC., ONE CONTINENTAL DRIVE, AUBURN HILLLS, MI, 48326-1581, US

(21) Appl. No.: 11/919,001

(22) PCT Filed: Apr. 19, 2006
(86) PCT No.: PCT/EP2006/061654

§ 371 Date: Oct. 22, 2007

(30) Foreign Application Priority Data
Apr. 25, 2005 (DE) 10 2005 019 392.7
Mar. 30, 2006 (DE) 10 2006 014 701.4

(51) Int. Cl. G01M 17/02; B60C 23/02; G01P 3/00

(52) U.S. Cl. 702/148; 73/146.3

(57) ABSTRACT

A method and a system for detecting the type of tire are disclosed, in particular in an indirectly measuring tire pressure monitoring system, which detects tire inflation pressure loss from the wheel rotational behavior. At least one modified vehicle tire is used, which incites specific patterns related to tire properties in the wheel rotational speed signal, and information about the tire is acquired by evaluation of the wheel rotational speed information.

### BACKGROUND OF THE INVENTION

The present invention relates to a method for detecting the type of tire, in particular for application in an indirectly measuring tire pressure monitoring system, and a system for detecting the type of tire.

It is of great significance for vehicle safety to reliably monitor the tire inflation pressure on all wheels of a motor vehicle or a motorcycle. German patent application DE 100 58 140 A1 discloses a method for the detection of tire pressure loss (DDS: Deflation Detection System) in motor vehicles, which allows determining tire pressure loss even without pressure sensors merely by evaluation of the wheel speeds, which are sensed anyway by means of wheel rotational speed sensors of the anti-lock system (ABS).

It has shown that the sensitivity of the tire, i.e. the variation of the rolling circumference of the tire due to tire pressure loss, has different results in different tires and types of tires. Thereby, spurious alarms can occur or alarms of the indirectly measuring tire pressure monitoring systems fail to appear.

Furthermore, the publication WO 2005/072995 A1 discloses a method for the indirect tire pressure monitoring, in which a prior art indirectly measuring tire pressure monitoring system (DDS) is improved taking into consideration the torsion natural frequency of the vehicle tires.

Besides, European patent EP 1 240 038 B1 discloses a method and a device for the detection of pressure loss in tires of motor vehicles, wherein speed patterns of the wheel rotational speed variation are detected, which are produced by specially conditioned emergency treads.

However, the method known from EP 1 240 038 B1 does not furnish information about the type of tire and the parameter associated therewith.

An object of the invention is to improve an indirectly measuring tire pressure monitoring system by taking into consideration the characteristics of the tire used.

### SUMMARY OF THE INVENTION

The invention is based on the idea that a tire allows recognizing relevant tire parameters, in particular information with regard to tire sensitivity, when rolling by inciting defined patterns in the rotational speed signal. To this end, the tire is modified in such a way that specific patterns related to tire properties are incited in the wheel rotational speed signal and are subsequently analyzed and evaluated. Thus, information about the tire can be acquired and can then be utilized in an indirectly measuring tire pressure monitoring system, for example.

In a preferred embodiment, the time variation of the wheel rotational speed signal/signals is directly analyzed in order to evaluate patterns contained therein.

In another preferred embodiment, a frequency analysis of the wheel rotational speed signal/signals is performed.

It is preferred that the specific patterns related to tire properties in the wheel rotational speed signal furnish information about the sensitivity of the vehicle tires. In an especially advantageous manner, the patterns indicate whether the vehicle tire possesses a sufficient rate of sensitivity for use in an indirect tire pressure monitoring system. In an especially preferred way, the specific patterns related to tire properties in the wheel rotational speed signal directly impart information how the dynamic tire radius and/or the torsion natural frequency of the tire change depending on the tire pressure or a tire pressure variation.

It is furthermore preferred that the specific pattern(s) related to tire properties contain(s) information about a type of tire and/or a tire dimension.

The vehicle tires are modified preferably at the profile, in the profile, at the tread, in the tread, at the side wall or in the side wall in order to incite specific patterns related to tire properties in the wheel rotational speed signal. As this occurs, it is especially preferred that enlargements in or at the tire incite specific patterns related to tire properties in the wheel rotational speed signal. It is also preferred that the tires are modified at an emergency tread being arranged inside the tire cover or on the wheel rim in order to incite specific patterns related to tire properties in the wheel rotational speed signal.

Especially favorably the method of the invention is implemented an indirect tire pressure monitoring system, which also evaluates the torsion natural frequency of the vehicle tires in order to detect tire pressure loss.

The advantage achieved by the invention resides in that an indirectly measuring tire pressure monitoring system can detect in a quick and simple fashion, whether the monitored tires, e.g. with regard to their sensitivity, are indeed suitable for the indirect tire pressure monitoring. If the tires are inappropriate, the system can output a warning to the operator indicating the problem.

The invention also relates to a system for detecting the type of tire, in which a method as described hereinabove is implemented.

Further preferred embodiments of the method of the invention can be taken from the subsequent description of embodiments by way of one FIGURE.

The dependency of the dynamic rolling radius ΔR_{dyn} as a function of the inflation pressure loss Δp differs to a large degree as regards different sets of tires. In indirectly measuring tire pressure monitoring systems (DDS: Deflation Detection System), the change of the dynamic rolling circumference/rolling radius is used as a standard of a tire pressure loss. When a fixed alarm threshold is used for a defined change in the dynamic rolling circumference in an indirectly measuring tire pressure system, an alarm is triggered regarding inflation pressure loss for different types of tires at different tire pressure levels.

It has been found out that it is favorable when a tire pressure monitoring system indicates to the driver by means of a display, the so-called malfunction display, as soon as the system is unable to offer full efficiency. As regards indirectly measuring tire pressure monitoring systems (such a case possibly prevails when spare tires do not exhibit a sufficient rate of tire sensitivity), in order to bring about a pressure alarm e.g. at −25% pressure difference already (that means, with a tire having normally 2.0 bar inflation pressure, an alarm would be output when the inflation pressure drops below 1.5 bar). It is difficult for indirect tire pressure systems to detect such tires. The invention solves this problem in that efficient original equipment tires, which exhibit a sufficiently high rate of tire sensitivity, disclose their identity by a defined signal. Whenever this signal is not observed, the malfunction display is switched on.

A modification of the original equipment tires achieves that defined frequencies are incited or a defined pattern in the rotational speed signal is incited or produced in the rolling action.

To this end, modifications are performed in the profile, below the tread, or in the side wall of the tire.
For example, a defined pattern can be impressed on the tire profile.
Elevations can be provided in the tread-groove base.
The tire can have enlargements over the circumference.
The bead-core profile can include enlargements.

These modifications are so insignificant that they do not impair the tire performance or the driving performance, although the modifications become apparent in the wheel rotational speed signal.

Regular arrangements can be chosen, which preferably incite determined wheel orders, i.e. frequencies, which represent a multiple of the wheel rotation frequency.

With the objective of minor effects on the tire performance, it is also possible to select ‘purposefully irregular’ arrangements, which do not favorably incite a wheel order, yet supply a significant ‘pattern’ in the order analysis. Thus, e.g. the amplitudes or the energies/energy densities of defined wheel orders may have a determined ratio to each other, and/or the amplitudes or the energies/energy densities of defined wheel orders, e.g. together, are by a defined factor in excess of the other wheel orders e.g. in a defined frequency range.

In the evaluating algorithm, e.g. frequency analyses are performed, or the time signal is already checked with regard to the significant pattern. Patent EP 1 240 038 B1 describes the algorithms to a wide extent.

### BRIEF DESCRIPTION OF THE DRAWING

FIG. 1 represents an exemplary embodiment of the method of the invention.

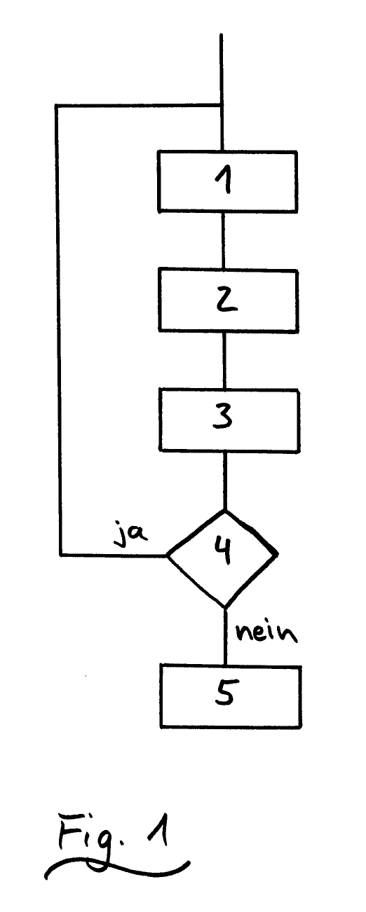

### DETAILED DESCRIPTION OF THE DRAWING

Block 1 reflects the recording/measurement of the wheel rotational speed signals of the individual wheels. The wheel rotational speed sensors of the anti-lock system (ABS) can e.g. take care of this action. The wheel rotational speed information is then analyzed in block 2, in particular by frequency analysis. Thereby, information about the tire, in particular, the tire sensitivity, is procured in block 3. A check is made in block 4 whether the sensitivity of the tires is sufficient for using the tires in an indirect tire pressure monitoring system. When the tires are not suitable, an alarm is output to the driver in block 5.

The tire can be detected by means of the overall system of special tires and an adapted algorithm, implemented into the control unit of an electronic brake system (EBS), for example. In this respect, it is even possible to choose a separate pattern for different types and dimensions of tires (e.g. depending on the tire manufacturer, width of tire cross-section, ratio between tire height and tire width, wheel rim diameter and other tire parameters) so that a distinction can be made between them as well.

The new overall system supplies the information to the improved indirectly measuring tire pressure monitoring system (DDS in consideration of the torsion natural frequency), whether the tires inhere the sensitivity that is required for pressure monitoring. In addition, it is even possible to furnish information about the type and dimension of tires so that, as the case may be, the detection thresholds for detecting tire inflation pressure loss can be adapted in the improved indirectly measuring tire pressure monitoring system.

Furthermore, other approaches for detecting the type of tire are also suitable, which will be mentioned hereinbelow:
Application of a specific torsion natural oscillation (fore-aft natural frequency) into the tire, which must lie outside the spectrum of current tires though, in order to render a distinction of spare tires possible,
Use of transponders in the tire or of other systems that can furnish information about the tire to the vehicle, and
Impressing a special magnetic signature on SWT-tires (SWT: Side Wall Torsion).

1-14. (canceled)

15. A method for detecting which type of tire is mounted on a vehicle wheel in an indirectly measuring tire pressure monitoring system, which detects tire inflation pressure loss from the wheel rotational behavior,
wherein a modified vehicle tire is used, which incites specific patterns related to tire properties in the wheel rotational speed signal, the method comprising the steps of
acquiring information about the tire by evaluation of rotational speed information,
determining that the mounted tire does not possess a sufficient rate of pressure sensitivity of its rolling circumference for use in an indirect tire pressure monitoring system, and
suspending the function of the indirectly measuring tire pressure monitoring system.

16. The method as claimed in claim 15,
wherein the evaluation of the wheel rotational speed information is performed by analyzing the time variation of the wheel rotational speed signal.

17. The method as claimed in claim 15,
wherein the evaluation of the wheel rotational speed information is performed by performing a torsion natural frequency analysis.

18. The method as claimed in claim 15,
wherein the information about the tire comprises at least one of the two following pieces of information: type of tire and tire dimension.

19. An indirectly measuring tire pressure monitoring system detecting the type of tire, including wheel rotational speed sensors, which detect tire inflation pressure loss from the wheel rotational behavior,
wherein the system comprises a modified vehicle tire, which incites specific patterns related to tire properties in the wheel rotational speed signal, and
wherein the system performs an evaluation of the specific patterns of wheel rotational speed signal.

20. A system as claimed in claim 19,
wherein the evaluation is performed in a frequency analysis of the torsion natural frequency of the vehicle tire.

21. The system as claimed in claim 19,
wherein the tire, includes modifications on at least one of the following points: at the profile, in the profile, at the tread, in the tread, at the side wall, in the side wall, at an emergency tread arranged within the tire cover or on the wheel rim.

22. The system as claimed in claim 19,
wherein the pattern produced in the wheel rotational speed signal by the modified vehicle tire is designed in such a way that information is contained as to whether the vehicle tire inheres a sufficient rate of pressure sensitivity of the rolling circumference for use in an indirect tire pressure monitoring system.

23. The system as claimed in claim 19,
wherein the pattern produced in the wheel rotational speed signal by the modified vehicle tire is designed in such a way that information is contained about a type of tire and/or a tire dimension.

24. The system as claimed in claim 19,
wherein the tire is modified on at least one of the following points with regard to specific tire properties: at the profile, in the profile, at the tread, in the tread, at the side wall, in the side wall, or at an emergency tread arranged within the tire cover or on the wheel rim.

25. The system as claimed in claim 24,
wherein enlargements in or at the tire are designed in such a manner that specific patterns related to tire properties are incited in the wheel rotational speed signal.

26. The system as claimed in claim 24,
wherein a pattern is impressed on the tire profile in such a way that specific patterns related to tire properties are incited in the wheel rotational speed signal.
